(19) United States
(12) Patent Application Publication
(10) Pub. No.: US 2016/0189145 A1
(43) Pub. Date: Jun. 30, 2016

(54) Consumer / Merchant payment processing system and methods of system use and operation

(71) Applicant: Mark William, Miami Gardens, FL (US)

(72) Inventor: Mark William, Miami Gardens, FL (US)

(21) Appl. No.: 14/583,248

(22) Filed: Dec. 26, 2014

(51) Int. Cl. G06Q 20/38; G06Q 20/10; G06Q 20/34; G06Q 20/40

(52) U.S. Cl. CPC G06Q 20/3821; G06Q 20/4012; G06Q 20/108; G06Q 20/34

(57) ABSTRACT

A method for a customer to establish a system account on my Payment Processing System website for executing merchant payment transactions; the customer visiting the website; the customer purchasing system service and receiving a code number and a personal identification number and receiving an email from customer service and the customer transferring funds from a bank account or a credit card account into the customer account by purchasing a corresponding number of website currency units; and the website storing and indicating the amount of website units in stored values. The method includes the additional steps for a new merchant to register to use the website; the website processing all data received from the merchant and confirming; and designating the merchant as a website registered merchant and the website operator integrate the merchant contents database into the present Payment Processing System merchant database. The method further includes the steps to execute a transaction with a registered merchant, including: the registered merchant accessing the customer account; the merchant entering an identification of an item and a service or contents to be purchased and the amount of the purchase; the customer pressing the system icon; the customer entering his or her code; the customer entering his or her personal PIN; the website verifying entered merchant information and customer code and PIN data and one of: approving and completing the transaction, and denying and canceling the transaction; and where the transaction is approved the website generating a confirmation code.

This application is a Continuation-in-Part application of Utility patent application Ser. No. 13/365,131 filed on Feb. 2, 2012 which benefited from provisional patent application Ser. No. 61/462,378 filed on Feb. 2, 2011.

### BACKGROUND OF THE INVENTION

1. Field of the Invention

The present invention relates generally to the field of payment systems, such as credit and debit cards and accounts offered through a payment service provider such as a credit card company or bank. In addition the present invention conceptualized for protecting Consumers and Merchant's.

More specifically the present invention is a safer and more convenient Payment Processing System for which Merchants are help being protected from being target by hackers and fraudulent behaviors; a Payment Processing System that does not share Consumers personal or confidential information with the Merchant to protect consumers against identity theft, which help protects banks, credit and debit card companies from high financial lost due to theft and fraudulent activities annually at merchant's online or brick and mortar, in addition a Payment Processing System that included an online merchant's Product contents downloadable controlled for each downloadable contents that allows consumers to enter their code number and personal pin numbers, in additional to a Payment Processing System for which no cash, checks, credit or debit cards information is needed for customers to pay merchant for purchases while shopping online or at brick and mortar, and finally a Payment Processing System wherein the customer can help another person by giving authorization to use his or her customer code and his or her personal identification number at a different location, and communicate the customer code and personal identification number to the person through a telephone, a text message and an email.

The present Payment Processing System includes a website and payment processing machines included a system icon on one of the payment processing machines and or the system icon on one of the pin pad processors provided by website operators to process transactions.

To use the system, a method is provided in which a customer establishes a system account, including the steps of the customer visiting the system website, the customer purchasing system service and receiving a customer code number and a personal identification number or PIN through the display of these numbers on the computer screen, and the system website sending customer an email from website customer service containing the code number and customer personal identification number or PIN; and the customer transferring funds from a bank account or from a credit card cash advance into a system customer account by purchasing website currency units; which preferably are identified as website units of currency corresponding directly to the units of currency of the country in which the purchase of website units is made; and the website storing and indicating the amount of website units created in stored values in the website account.

Additional method steps are provided, for a merchant to register to use the website, including: a new merchant visiting the website, the new merchant entering an email address; the new merchant receiving a registration form and inputting data into the form, and the merchant returning the form to the website providing company, such as electronically or through hand delivery to a company representative; the website processing all data received from the merchant and confirms that the merchant is a legal business and has a valid bank account; the website verifies the merchant and providing the merchant with a password; and the website operators integrate online merchant's contents into the present Payment Processing System merchant contents database and providing at the merchant location a merchant pin pad processor connected to the system website through the internet

Still additional method steps are provided for a customer execute a transaction with the merchant, such as to make a purchase, including: the customer visiting the online store and or the brick and mortar store; the merchant accessing the customer member account; the merchant entering the merchant password and an identification of the downloadable contents, item or service to be purchased together with the amount of the purchase price on the Payment Processing System website; the customer pressing the system icon; the customer entering his or her customer code; the customer entering his or her personal PIN; the website verifying entered merchant information and customer code and PIN data and doing one of: approving and completing the transaction, and denying and canceling the transaction; and, where the transaction is approved, the website generating a confirmation code; and the website sending each of the customer and the merchant an email verification of the approved and completed transaction.

Finally further additional steps are provided for a merchant to view and check their company statement on the website, by the merchant entering their password provided by the present Payment Processing System.

2. Description of the Prior Art

There have long been credit cards and debit cards for executing purchase transactions without cash. A problem with such card based transactions has been that the card can be lost or stolen, leading to theft of customer funds, or can be simply left behind at home when needed.

There has also been merchant's product contents online being downloaded by consumers and such downloads sometimes included illegal downloads including movies, songs, e-books and other copyright contents that cost a big lost for merchants annually.

It is thus an object of the present invention to provide such a Payment Processing System that included merchant's downloadable contents in which consumers enters there customer code and personal identification number or PIN for downloadable contents including movies, songs, e-books and other copyright contents.

It is still another objective of the present invention to provide a cashless Payment Processing System for which no card is provided or required, and therefore a payment system in which no account can be jeopardized or subject to fraudulent withdrawals through loss or theft of a card, and for which no cash is required and thus no cash is placed at risk of loss or theft.

It is another objective of the present invention to provide such a cashless payment system for which no credit need be established or demonstrated.

It is another object of the present invention to uses any communication devices with internet connection for customers to shop at online stores including; a smart phone, tablet and a personal computer.

It is also another objective of the present invention to provide such a cashless Payment Processing System for which customer can give another person authorization to use his or her customer code and his or her personal identification number at a different location, and communicate the customer code and personal identification number to the person through a telephone, a text message and an email.

It is yet another objective of the present invention to provide such a cashless Payment Processing System which is convenient because it can store monetary value at the touch of a button using consumer's account of stored values.

It is finally an object for the present invention to help protect consumers, merchants, banks, credit and debit card companies from high financial lost due to hackers, theft and fraudulent activities online or in-store business annually.

### SUMMARY OF THE INVENTION

The present invention accomplishes the above-stated objectives, as well as others, as may be determined by a fair reading and interpretation of the entire specification.

A method is provided for a customer to establish a system account on a Payment Processing System website for executing merchant payment transactions, including the steps of: providing a website

the customer visiting the system website; the customer purchasing system service and receiving a code number and a personal identification number and receiving an email confirmation containing these numbers from customer service and the customer transferring funds from one of a bank account a credit card account into the customer system account by purchasing a corresponding number of website currency units; and the website storing and indicating the amount of website units in the customer website account of stored values.

The method preferably includes the additional steps for a new merchant to register to use the website, including: a merchant visiting the website; the merchant entering an email address; the merchant receiving a registration form, inputting data into the form, and returning the form to the website providing company; the website processing all data received from the merchant and confirming; and the website verifying the merchant and designating the merchant as a website registered merchant;

The method preferably further includes the additional steps to execute a transaction with a registered merchant, including: the registered merchant accessing the customer account; the merchant clicking on an identification of one of an item and a service or a downloadable contents to be purchased; the merchant entering the merchant password; the customer presses the system icon; the customer entering his or her code; the customer entering his or her personal PIN; the website verifying entered merchant information and customer code and PIN data and one of: approving and completing the transaction, and denying and canceling the transaction; and where the transaction is approved the website generating a confirmation code; and the website sending the each of the customer and the registered merchant an email verification of the approved and completed transaction.

Several bullet points about the present invention are that: the Payment Processing System server collects and securely stores customer information and uses such information when requested by the customer to activate the customer account of stored values; the brick and mortar merchant pin pad connected to a personal computer, that has a driver which is located onto the personal computer that communicates with the pin pad; the system server is able to recognize the merchant ID, which is the merchant IP address and personal computer; the merchant access system server to process a customer transaction; the merchant connects to the website identified by the merchant port, and the system server provides a pop-up window that communicates with the merchant pin pad driver, that receives entry from the system pin pad; the customer enters his or her customer code and PIN numbers at the system pin pad then verifies the system customer account and transfer funds into the system merchant account; the customer uses his or her code and personal PIN number until he or she is out of funds; return funds from the system customer account are manually returned by the system customer account center; return item at merchant, the merchant must login to the website and access a return icon to make the necessary return for the customer.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a schematic illustrating the method by which the present Payment Processing System website functions, transferring of funds safely from registered consumer's bank account to registered merchant bank account.

FIG. 2 is a flow chart representation of the present system, including a transaction processing flow chart. is a flow chart illustrating the method by which the present website functions

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

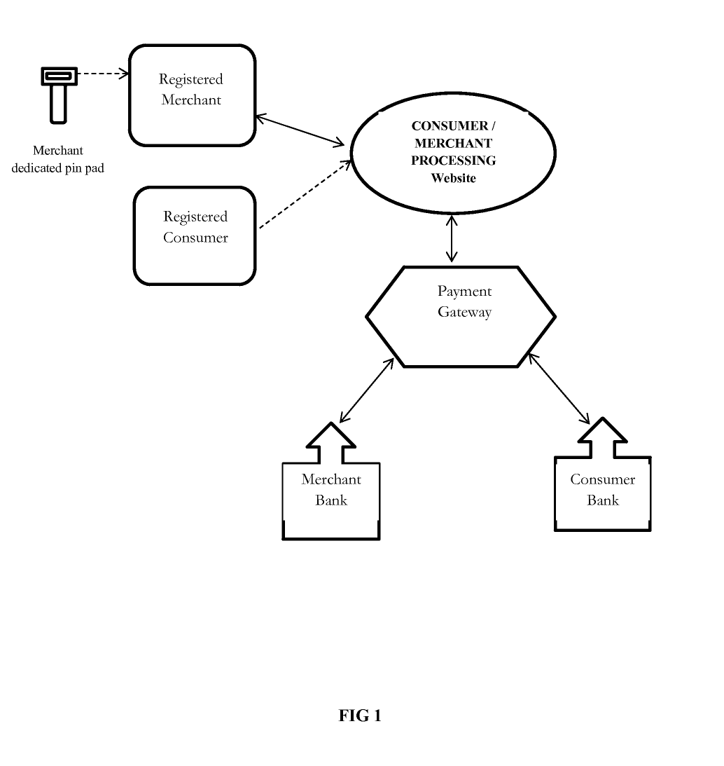

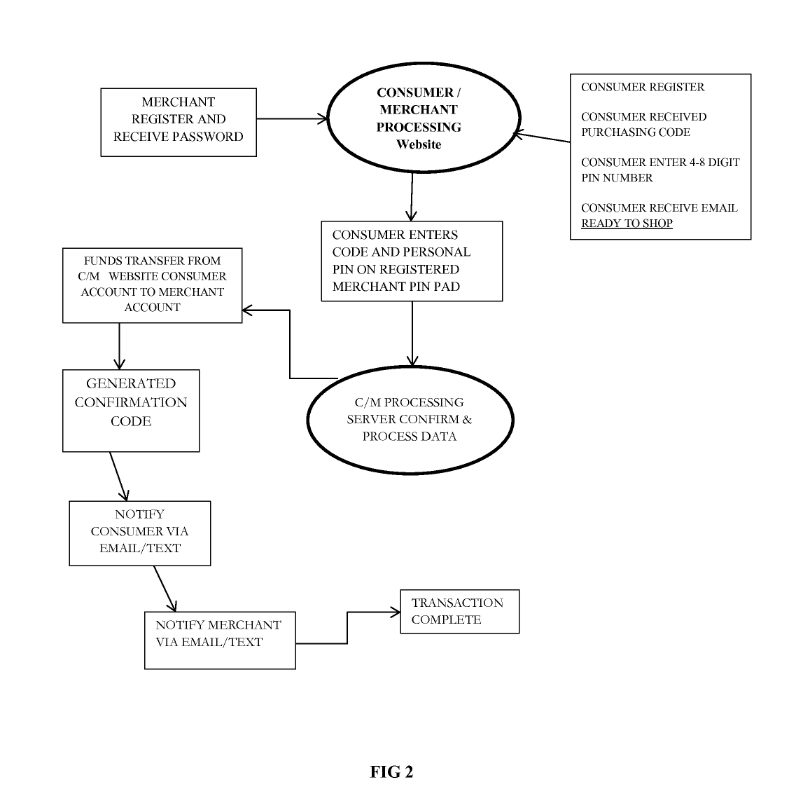

Referring to FIGS. 1-2, a website based Payment Processing System is disclosed including as apparatus a website having a website processing service and a customer to merchant transaction webpage, and banks and payment processing machines for use by customer, including a dedicated website pin pad at the merchant location.

The pin pad may be connected to a personal computer (PC) also at merchant location, but alternatively may function independently without connection to a PC.

### Method

To use the Payment Processing System, a method is provided in which a customer establishes a system account for executing purchase transactions with merchants, including the steps of: the customer visiting the website; the customer transferring funds from a bank account or a credit card account to purchase website units of currency; the website processing service securing the funds from the website customer bank account or credit card account and depositing the funds into a customer account; the customer approaching a website registered merchant and proposing to purchase contents, good's or service with website currency, the website providing the customer with a customer account number and a personal identification number or PIN.

Further method steps include the merchant accessing the customer account by logging onto the website, preferably using a dedicated website button which links directly to the website merchant/customer transaction web page; the customer pressing the system icon; the customer entering his customer code and his personal PIN using a dedicated website pin pad; the website processor processing the data and confirming customer identity and providing customer access to his or her website account; the registered merchant receiving confirmation information from the website to do one of accept or deny the transaction; the customer and merchant receiving a confirmation email receipt for the transaction; the website bank transferring funds from the website customer account to the website outlet merchant bank account; the website giving the registered merchant a transaction rate, and the website processor deducting a set percentage of each transaction amount and depositing it into the website business bank account.

Consumer's information for establishing a website customer system account preferably includes the customer name, customer billing address, customer email address, customer date of birth, a security question requiring a pre-set customer answer, an Internet provider name.

The information provided by the merchant preferably includes legal business name and address, email address, Internet provider name and computer IP address. A pin pad serial number preferably is provided to the website registered merchant.

The website provides a return method for reversing completed customer/merchant purchase transactions, including the steps of: the customer providing the confirmation number and his or her email address to the registered merchant; the registered merchant enter password and logging into the merchant access and pressing a return icon; the merchant entering the confirmation number and e-mail and access the customer payment transaction; a search engine confirming the transaction was made; and the merchant's making the necessary return item transaction as requested by the customer.

In the event that a charge-back is required, that account is automatically deducted from the merchant account until an investigation is completed. The customer is required to update any changes in stored customer information, and the website verifies and confirms such customer updates.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. A method of making a payment utilizing a computer implemented Payment Processing System connected to the internet integrated with merchant and customer human interaction, comprising the steps of:
providing a system website;
providing at the merchant location a merchant pin pad connected to the system website through the internet;
a merchant visiting the system website and registering to use the system to become a registered merchant and receiving a merchant password;
a customer visiting the system website and registering to use the system to become a registered customer and receiving a customer code number and a personal identification number;
the customer entering the customer code number and personal identification number on the merchant pin pad and thereby accessing a customer account of stored values in website currency units for purchasing one of an item and a service from a merchant;
the customer creating a system customer account of stored values in website currency units on the system website, and funding the system customer account by transferring funds from one of a customer bank account and a customer credit card account into the system customer account by purchasing a number of website currency units, and the website storing and indicating the number of website currency units in the system customer account of stored values;
the customer physically visiting the merchant location and selecting one of an item and a service to purchase having a stated amount of purchase in website currency units;
the merchant entering on the system website the merchant password and an identification of the one of an item and a service to be purchased, and the amount of the purchase;
the customer pressing the system icon;
the customer entering his or her customer code;
the customer entering his or her personal identification number, into the merchant dedicated pin pad connected to the system website through the internet such that the customer has no need to give or share personal and confidential information with a merchant;
and the website verifying the entered merchant information and the customer code and personal identification number, while the consumers physically at the brick and mortar and or in-store, paying at a merchant using the internet and one of:
approving and completing the transaction, and denying and canceling the transaction.

2. The method of claim 1, comprising the additional steps for a new merchant to register to use the Payment Processing System website, comprising:
the merchant entering an email address;
the merchant receiving a registration form, inputting data into the form, and returning the form to the website providing company;
the website processing all data received from the merchant and confirming;
and the website verifying the merchant and designating the merchant as a website registered merchant.

3. The method of claim 1, wherein a Payment Processing System website currency units are identified as website units of currency corresponding directly to the units of currency of the country in which the purchase of website units is made.

4. The method of claim 1, a Payment Processing System wherein the customer gives another person authorization to use his or her customer code and his or her personal identification number at a different location, and communicate the customer code and personal identification number to the person through one of a telephone conversation, a text message and an email.
the customer pressing the system icon;
the customer entering his or her customer code;
the customer entering his or her personal PIN into the merchant dedicated pin pad.

5. The method of claim 1, wherein My Payment Processing System securely registered and storing consumers and merchant information by ways of using the internet and a system website; and using such internet and system website to process consumer/merchant transaction using the merchant dedicated pin pad connected to the system website through the internet while not sharing consumer information with the merchant online or in-stores help protects merchants from being a target by hackers and fraudulent behavior, and protects banks, credit and debit card companies from high financial lost due to theft and fraudulent activities annually at merchant's online or in-store businesses.

6. The method of claim 1, comprising the additional steps for a Payment Processing System that does not share Consumers personal or confidential information with the Merchant to protect consumers against identity theft; which help protects banks, the card companies, and online or in-store merchant's.
the customer pressing the system icon;
the customer entering his or her customer code;
the customer entering his or her personal PIN into the merchant dedicated pin pad connected to the system website through the internet.

7. The method of claim 1, wherein a Payment Processing System for which no cash, checks, credit or debit cards information is needed for customers to pay a merchant for purchases while shopping online or at brick and mortar and or in-store, by
the customer pressing the system icon;
the customer entering his or her customer code;
the customer entering his or her personal PIN into the merchant dedicated pin pad connected to the system website through the internet.

8. A method of making a payment utilizing a computer-implemented Payment Processing System connected to the internet integrated with merchant and customer human interaction, comprising the steps of:
providing a system website;
providing at the merchant location a merchant pin pad connected to the system website through the internet;
a merchant visiting the system website and registering to use the system to become a registered merchant and receiving a merchant password;
a customer visiting the system website and registering to use the system to become a registered customer and receiving a customer code number and a personal identification number;
the customer creating a system customer account of stored values in website currency units on the website, and funding the system customer account by transferring funds from one of a customer bank account and a customer credit card account into the system customer account by purchasing a number of website currency units, and the website storing and indicating the amount of website currency units in the system customer account of stored values;
the customer physically visiting the merchant location and selecting one of an item and a service to purchase having a stated amount of purchase;
the merchant entering on the system website the merchant password and an identification of the one of an item and a service to be purchased, and the amount of the purchase;
the customer pressing the system icon;
the customer entering his or her customer code;
the customer entering his or her personal identification number, into the merchant dedicated pin pad connected to the system website through the internet such that the customer has no need to give or share personal and confidential information with a merchant;
and the website verifying the entered merchant information and the customer code number and personal identification number, while the consumers physically at the brick and mortar and or in-store, paying at a merchant using the internet and one of:
approving and completing the transaction, and denying and canceling the transaction.

9. The method of claim 8, comprising the additional steps for a new merchant to register to use the Payment Processing System website, comprising:
the merchant entering an email address;
the merchant receiving a registration form, inputting data into the form, and returning the form to the website providing company;
the website processing all data received from the merchant and confirming;
and the website verifying the merchant and designating the merchant as a website registered merchant.

10. The method of claim 8, wherein a Payment Processing System website currency units are identified as website units of currency corresponding directly to the units of currency of the country in which the purchase of website units is made.

11. The method of claim 8, a Payment Processing System wherein the customer gives another person authorization to use his or her customer code and his or her personal identification number at a different location, and communicate the customer code and personal identification number to the person through one of a telephone conversation, a text message and an email.
the customer pressing the system icon;
the customer entering his or her customer code;
the customer entering his or her personal PIN into the merchant dedicated pin pad.

12. The method of claim 8, wherein My Payment Processing System securely registered and storing consumers and merchant information by ways of using the internet and a system website; and using such internet and system website to process consumer/merchant transaction using the merchant dedicated pin pad connected to the system website through the internet while not sharing consumer information with the merchant online or in-stores help protects merchants from being a target by hackers and fraudulent behavior, and protects banks, credit and debit card companies from high financial lost due to theft and fraudulent activities annually at merchant's online or in-store businesses.

13. The method of claim 8, comprising the additional steps for a Payment Processing System that does not share Consumers personal or confidential information with the Merchant to protect consumers against identity theft; which help protects banks, the card companies, and online or in-store merchant's.
the customer pressing the system icon;
the customer entering his or her customer code;
the customer entering his or her personal PIN into the merchant dedicated pin pad connected to the system website through the internet.

14. The method of claim 8, wherein a Payment Processing System for which no cash, checks, credit or debit cards information is needed for customers to pay a merchant for purchases while shopping online or at brick and mortar and or in-store, by
the customer pressing the system icon;
the customer entering his or her customer code;
the customer entering his or her personal PIN into the merchant dedicated pin pad connected to the system website through the internet.

15. The payment method of claim 8, comprising the additional steps of the Payment Processing System website generating a confirmation code when a transaction is approved, and the website sending at least one of the customer and the registered merchant an email verification of the approved and completed transaction.

16. A method of making a purchase from a merchant through an online store having a check-out function utilizing a computer-implemented Payment Processing System connected to the internet, comprising the steps of:
providing a system website;
providing a communications device in the form of one of a pin pad processor;
providing a system icon on one of the pin pad processor;
a merchant visiting the system website and registering to use the system to become a registered merchant and receiving a merchant password;
and the website operators integrating the online merchant contents into the Payment Processing System merchant contents database.
a customer visiting the system website and registering to use the system to become a registered customer and receiving a customer code number and a personal identification number;
the customer creating a system customer account of stored values in website currency units on the website, and funding the system customer account by transferring funds from one of a customer bank account and a customer credit card account into the system customer account by purchasing a number of website currency units, and the website storing and indicating the number of website currency units in the system customer account of stored values;
the merchant entering on the system website the merchant password and an identification of the one of an item and a service or downloadable contents to be purchased, and the amount of the purchase;
the customer pressing the system icon;
the customer entering his or her customer code;
the customer entering his or her personal identification number, into the merchant dedicated pin pad connected to the system website through the internet such that the customer does not share personal or confidential information with the merchant website;
the customer visiting the online store;
the merchant clicking on an identification of one of an item and a service or a downloadable contents to be purchased showing the amount of the purchase;
the customer purchasing the item or service through the registered merchant online store;
and the system website verifying the registered merchant information and the customer code and personal identification number and one of: approving and completing the transaction, and denying and canceling the transaction.

17. The method of claim 16, a Payment Processing System wherein the customer purchases the item and service or downloadable contents through a check-out function by performing the steps of pressing the system icon; the customer entering his or her customer code; the customer entering his or her personal pin number through into the customer communications device.

18. The method of claim 16, a Payment Processing System wherein the customer gives another person authorization to use his or her customer code and his or her personal identification number at a different location, and communicate the customer code and personal identification number to the person through one of a telephone conversation, a text message and an email.
the customer pressing the system icon;
the customer entering his or her customer code;
the customer entering his or her personal PIN into the merchant dedicated pin pad.

19. The method of claim 16, wherein a Payment Processing System for which no cash, checks, credit or debit cards information is needed for customers to pay a merchant for purchases while shopping online or at brick and mortar and or in-store, by the customer pressing the system icon; the customer entering his or her customer code; the customer entering his or her personal PIN into the merchant dedicated pin pad connected to the system website through the internet.

20. The method of claim 16, comprising the additional steps for a Payment Processing System that does not share Consumers personal or confidential information with the Merchant to protect consumers against identity theft; which help protects banks, the card companies, and online or in-store merchant's.
the customer pressing the system icon;
the customer entering his or her customer code;
the customer entering his or her personal PIN into the merchant dedicated pin pad connected to the system website through the internet.

21. The method of claim 16, a Payment Processing System comprising the additional steps of processing online merchant's Product contents in a controlled manner for which consumers enters there payment credential using the system icon on one of the merchant pin pad processors by the customer pressing the system icon; the customer entering his or her customer code; the customer entering his or her personal PIN for downloadable contents while shopping on the merchant website.

22. The method of claim 16, a Payment Processing System wherein the said communications devices is one of: a smart phone, a tablet and a personal computer with internet connection by the customer pressing the system icon; the customer entering his or her customer code; the customer entering his or her personal PIN into the said communications device.

23. The method of claim 16, wherein My Payment Processing System securely registered and storing consumers and merchant information y ways of using the internet and a system website; and using such internet and system website to process consumer/merchant transaction using the merchant dedicated pin pad connected to the system website through the internet while not sharing consumer information with the merchant online or in-stores help protects merchants from being a target by hackers and fraudulent behavior, and protects banks, credit and debit card companies from high financial lost due to theft and fraudulent activities annually at merchant's online or in-store businesses.

24. The method of claim 16, wherein a Payment Processing System website currency units are identified as website units of currency corresponding directly to the units of currency of the country in which the purchase of website units is made.

25. The method of claim 16, wherein the downloadable content is one of a movie, songs, e-books and other copyright contents by the customer pressing the system icon; the customer entering his or her customer code; the customer entering his or her personal PIN into the said communication device.
